(19) United States
(12) Patent Application Publication
(10) Pub. No.: US 2008/0022326 A1
(43) Pub. Date: Jan. 24, 2008

(54) Wireless transmission method for electronic apparatuses to transmit audio and visual signals to television and device thereof

(75) Inventors: Tain-Rein Chen, Hsinchu (TW); Chao-Kai Sung, Hsinchu (TW)

Correspondence Address: Cooper & Dunham LLP, 1185 Avenue of the Americas, New York, NY, 10036, US

(73) Assignee: Avid Electronics Corp.

(21) Appl. No.: 11/479,867

(22) Filed: Jun. 30, 2006

(51) Int. Cl. H04N 7/18

(52) U.S. Cl. 725/81

(57) ABSTRACT

A wireless transmission method for electronic apparatuses to transmit audio and visual signals to a television and device thereof include steps as follows. First, audio and visual signals that electronic apparatuses desire to play are modulated. Then the modulated audio and visual signals are transformed to television carrier signals via a low-power television signals wireless transmitter. The television carrier signals are sent to a television by setting the electronic apparatuses near the television. With a very short distance between the electronic apparatuses and the television, the transmitted carrier signals can go through the television to a tuner inside the television, then the tuner can direct receive the television carrier signals. In this way, the transmission method of the present invention does not need signal transmission lines between the electronic apparatuses and the television.

### BACKGROUND OF THE INVENTION

1. Field of the Invention

The invention relates in general to a method and device thereof, and more particularly to a wireless transmission method for electronic apparatuses to transmit audio and visual signals to a television and device thereof; which especially refers to the method and device that do not require a signal transmission line and only require placing the device of the present invention near a television to transmit audio and visual signals to the television.

2. Description of the Related Art

General electronic apparatuses that can play audio and visual signals such as a videodisc player usually use audio and video connectors such as an AV-terminal, an S-terminal, a chrominance terminal and the like to be coupled to a television via a transmission line, so that the television can display audio and visual signals output from the electronic apparatus.

A convention television only provides three sets of audio and video connectors for external connected electronic apparatuses. If more than three electronic apparatuses are desired to be coupled to the television, the audio and video connectors of the television are insufficient. Hence the coupling of the electronic apparatuses and the television has to be re-connected to switch to different electronic apparatuses. In this way, not only the reconnection is very inconvenient but also the lines are disorderly and hard to manage; and even worse may further cause a poor contact due to constantly pull out plugs. For those electronic apparatuses required using very often by external connection such as a digital camera or a DV video camera, one or more than one external exposed signal lines is necessary. Hence the lines are very messy. Further, to plug electric wirings is not that simple to everyone, which indicates difficulties in use.

### SUMMARY OF THE INVENTION

A main objective of the present invention is to provide a wireless transmission method for electronic apparatuses to transmit audio and visual signals to a television. The wireless transmission method makes the television to direct play the audio and visual signals without audio and video connectors. In order to achieve the above objective, a main technique of the present invention includes steps as follows.

First, the audio and visual signals that electronic apparatuses desire to play are modulated. Then the modulated audio and visual signals are transformed to television carrier signals via a low-power television signals wireless transmitter. The television carrier signals are sent to a television by setting the electronic apparatuses near the television. With a very short distance between the electronic apparatuses and the television, the transmitted television carrier signals can go through the television to a tuner inside the television, then the tuner can direct receive the television carrier signals. The television then can direct play the audio and visual signals of the electronic apparatuses by tuning the television to a corresponding frequency of the television carrier signals. In this way, the transmission method of the present invention does not need signal transmission lines between the electronic apparatuses and the television.

Another main objective of the present invention is to provide a wireless transmission device for electronic apparatuses to transmit audio and visual signals to a television. The wireless transmission device includes a modulation module and a low-power wireless transmission module.

The modulation module is used to receive and transform the audio and visual signals of the electronic apparatuses to a format suitable to be transmitted by a transmission media. The low-power wireless transmission module is coupled to the modulation module for transmitting the modulated audio and visual signals.

The present invention uses the wireless transmission method to send the audio and visual signals, so as to get rid of the inconvenience of messy lines problems of the audio and video connectors between the electronic apparatuses and the television.

The television can be a conventional television or a digital television. When the digital television is used, the present invention further includes an encoding module and a converter module. The encoding module is used to convert the audio and visual signals to digital data. The converter module is coupled between the modulation module and the encoding module for converting the digital data to a standard digital data of a digital television broadcast system.

When the present invention is applies to a mobile, a digital camera, a videodisc player or a digital photo frame, the wireless transmission device of the present invention can be installed inside the electronic apparatuses. On the other hand, when the present invention is applies to a laptop or a desktop, a connector interface can be used to be coupled to the computer.

Furthermore, the present invention can further include an auxiliary antenna installed at an antenna input cable of a television. The auxiliary antenna includes a cable configured with a metal extending part for enhancing reception sensitivity of the television.

### BRIEF DESCRIPTION OF THE DRAWINGS

FIG. 1 shows a schematic configuration of an application of method in accordance with the present invention;

FIG. 2A shows a television with an auxiliary antenna used in the method of the present invention;

FIG. 2B is a perspective view of the auxiliary antenna in accordance with the present invention;

FIG. 3 is a block diagram of a first preferred embodiment of a wireless transmission device in accordance with the present invention;

FIG. 4 is a block diagram of a second preferred embodiment of a wireless transmission device in accordance with the present invention;

FIG. 5A is a block diagram of a third preferred embodiment of a wireless transmission device in accordance with the present invention;

FIG. 5B is a block diagram of a fourth preferred embodiment of a wireless transmission device of the present invention;

FIG. 6A is a block diagram of a fifth preferred embodiment of a wireless transmission device in accordance with the present invention; and

FIG. 6B is a block diagram of a sixth preferred embodiment of a wireless transmission device in accordance with the present invention.

### DETAILED DESCRIPTION OF THE INVENTION

A wireless transmission method for electronic apparatuses to transmit audio and visual signals to a television of the present invention includes steps as follows.

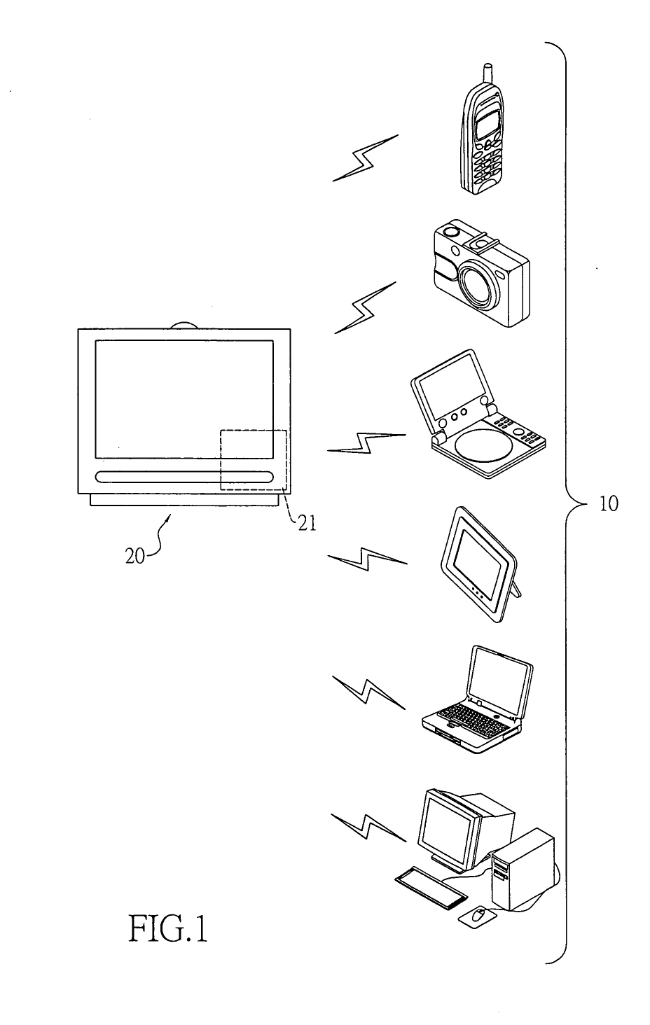

With reference to FIG. 1, audio and visual signals that electronic apparatuses (10) such as a mobile phone, a digital camera, a videodisc player, a digital photo frame, a laptop or a desktop desire to play are modulated.

The modulated audio and visual signals are then transformed to television carrier signals via a low-power television signals wireless transmitter. A distance between the electronic apparatuses (10) and the television (20) is very short, thereby the television carrier signals are sent to a television (20).

The transmitted carrier signals go through the television (20) to a tuner (21) inside the television (20). The television (20) then can direct play the audio and visual signals of the electronic apparatuses (10) when the television (20) is tuned to a setting frequency of the present invention. In this way, the transmission method of the present invention does not need signal transmission lines between the electronic apparatuses and the television.

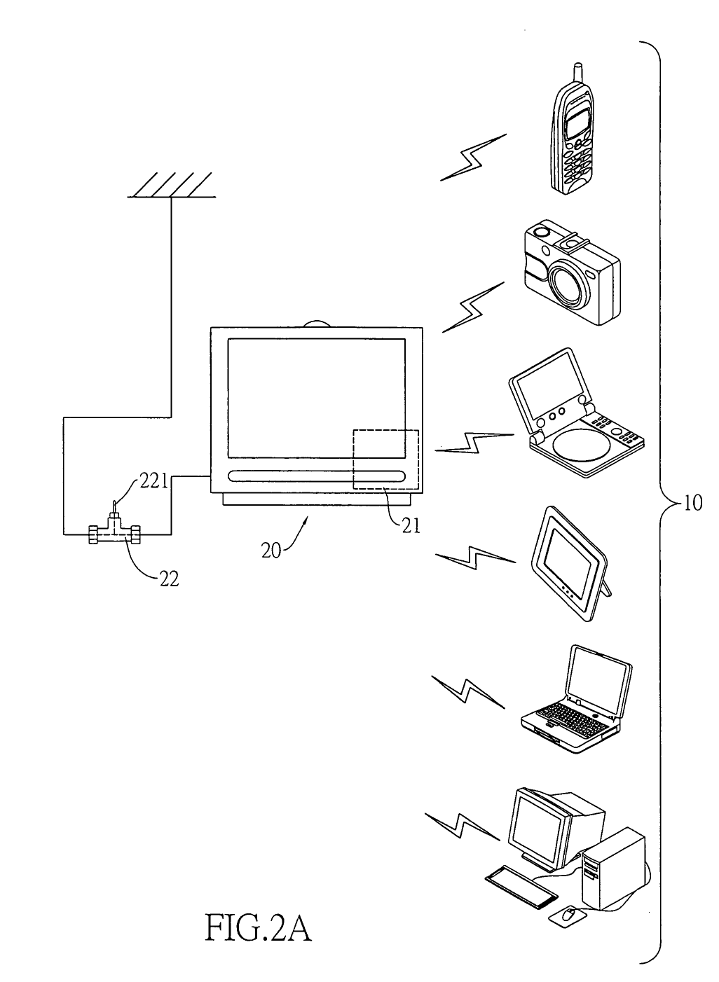

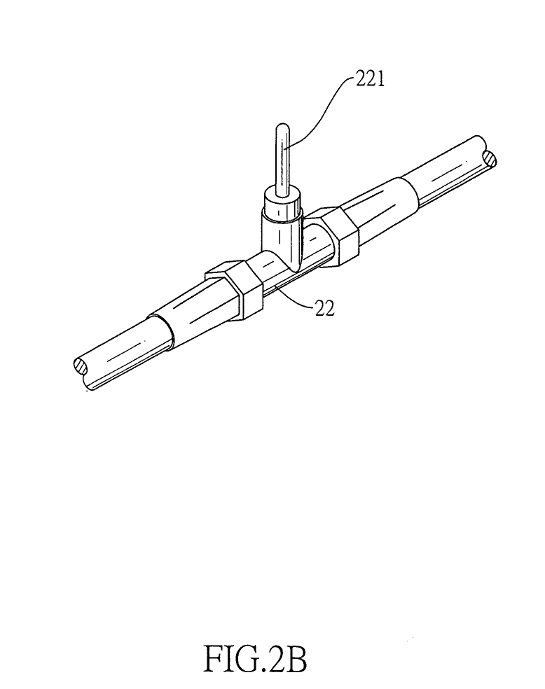

With reference to FIG. 2A and FIG. 2B, the method of the present invention can be implemented by further adding an auxiliary antenna (22) installed on an antenna input cable of a television (20). The auxiliary antenna (22) includes a cable configured with a metal extending part (221) having two sides that are in and out ends to be coupled to a television antenna. The perpendicular metal extending part (221) of the auxiliary antenna (22) forms as an indoor antenna, so as to increase reception strength of the television (20) for enhancing reception of the audio and visual signals sent by the present invention.

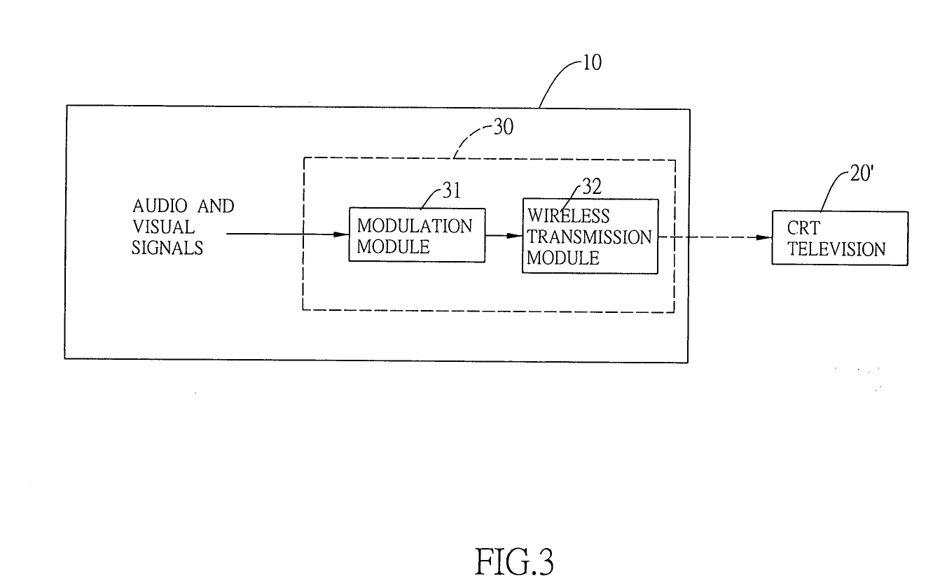

With further reference to FIG. 3, a first preferred embodiment of a wireless transmission device (30) for the electronic apparatus to transmit audio and visual signals to a television of the present invention is applied to electronic apparatus (10) such as a mobile phone, a digital camera, a videodisc player, or a digital photo frame. The wireless transmission device (30) is combined in the electronic apparatus (10). By installing the wireless transmission device (30) of the present invention to the electronic apparatuses (10), the audio and visual signals that the electronic apparatuses (10) desire to play are transmitted to a CRT television (20′) to play. The wireless transmission device (30) includes a modulation module (31) and a wireless transmission module (32) inside the wireless transmission device (30) and connected to the modulation module (31).

The modulation module (31) is used to transform the audio and visual signals of the electronic apparatus (10) to a format suitable to be transmitted by a transmission media. In this preferred embodiment, an analog modulator is used.

The wireless transmission module (32) is coupled to the modulation module (31) for transmitting the modulated audio and visual signals. In this preferred embodiment, an ultrahigh frequency (UHF) transmitter is used.

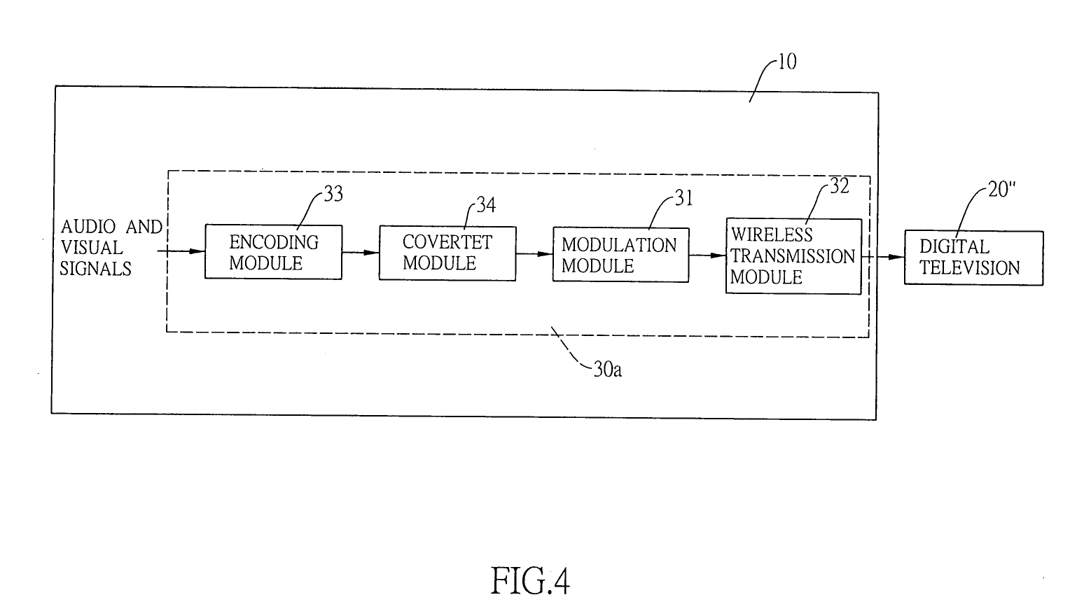

With reference to FIG. 4, a second preferred embodiment of a wireless transmission device (30a) of the present invention is approximately similar to the wireless transmission device in the first preferred embodiment. The difference is that the wireless transmission device (30a) is used to transmit audio and visual signals to be played to a digital transmitter of a digital television (20″). Hence the wireless transmission device (30a) adds an encoding module (33) and a converter module (34) in comparison with the wireless transmission device of the first preferred embodiment. The converter module (34) is coupled between the modulation module (31) and the encoding module (33).

The modulation module (31) uses an orthogonal frequency division multiplexing (OFDM) modulator. The encoding module (33) is used to convert the audio and visual signals to digital data. In this preferred embodiment, an Mpeg-2 (motion picture experts group) encoder is used. The converter module (34) is used to convert the digital data to a standard digital data of a digital television broadcast system. In this preferred embodiment, the digital data is converted to the standard digital data of a DVB-T (Digital Video Broadcasting-terrestrial).

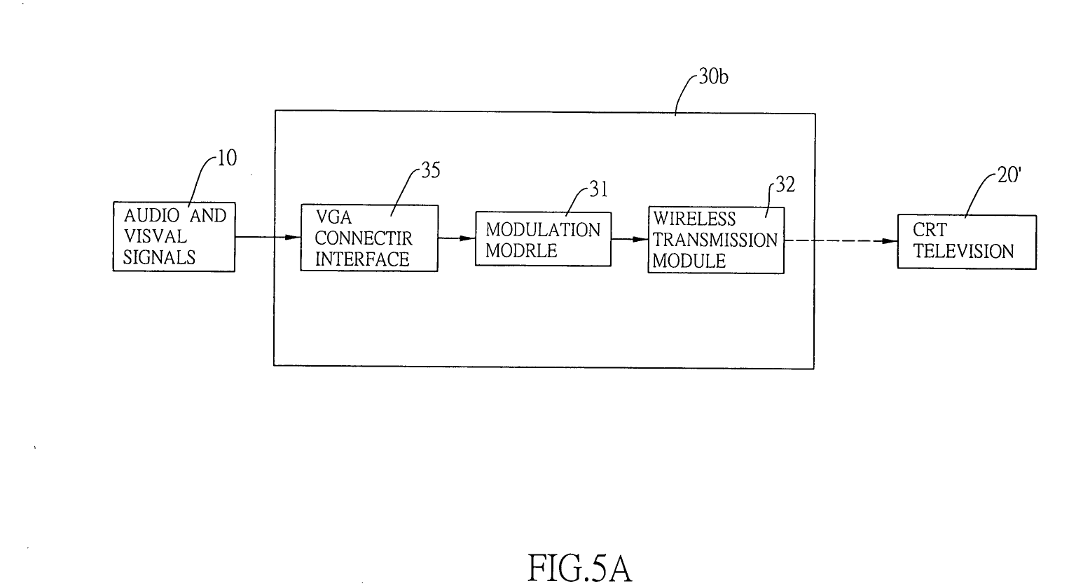

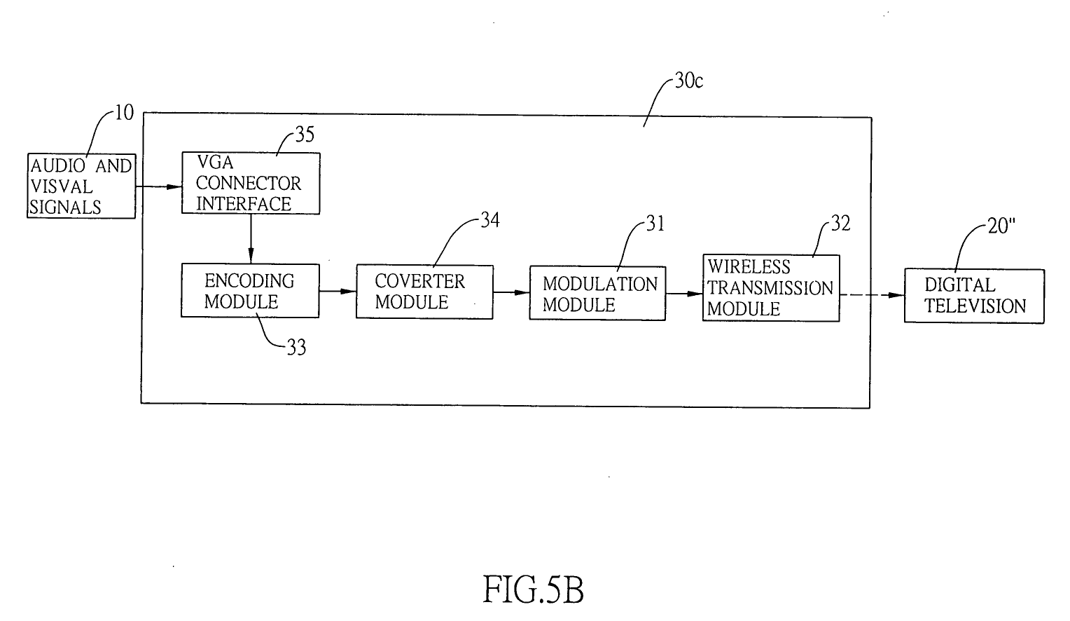

With reference to FIG. 5A, a third preferred embodiment of a wireless transmission device (30b) of the present invention is approximately similar to the wireless transmission device in the first preferred embodiment. The wireless transmission device (30b) can be made to an independent product separated from the electronic apparatus (10).

The difference is that the wireless transmission device (30b) of this preferred embodiment adds a VGA connector interface (35) in comparison with the wireless transmission device of the first preferred embodiments, so as to construct an independent wireless transmitter. The VGA connector interface (35) is used for coupling with an analog signal output terminal of a laptop or desktop for example.

With reference to FIG. 5B, a fourth preferred embodiment of a wireless transmission device (30c) of the present invention is approximately similar to the wireless transmission device in the second preferred embodiment. The difference is that the wireless transmission device (30c) of this preferred embodiment adds a VGA connector interface (35) in comparison with the wireless transmission device of the second preferred embodiments, so as to construct an independent wireless transmitter. The VGA connector interface (35) is used for coupling with an analog signal output terminal of a laptop or desktop for example.

Furthermore, FIG. 5A and FIG. 5B respectively show an analog circuit and a digital circuit of the wireless transmission device 30 of the present invention.

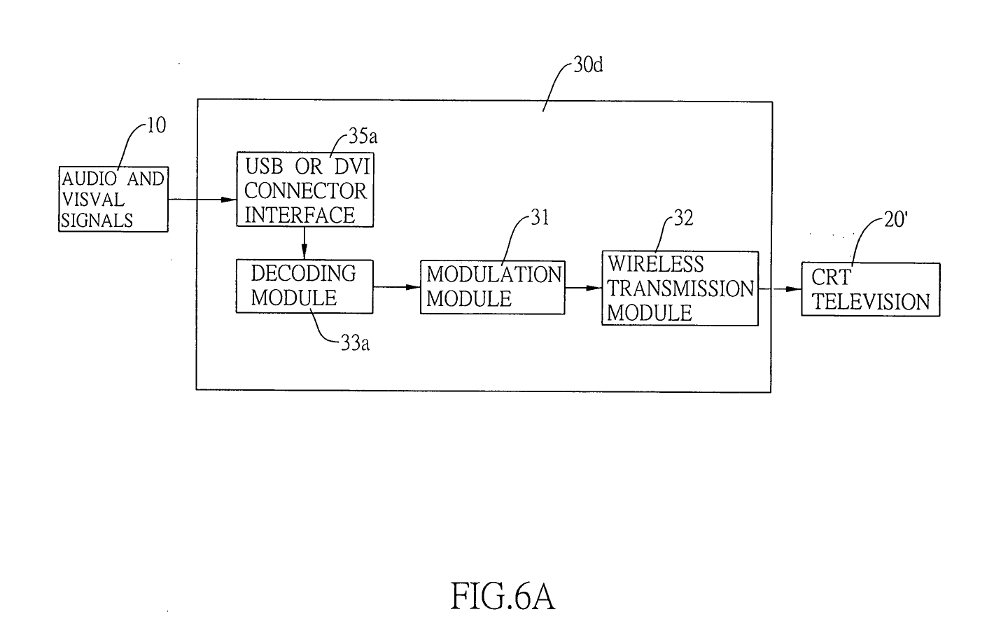

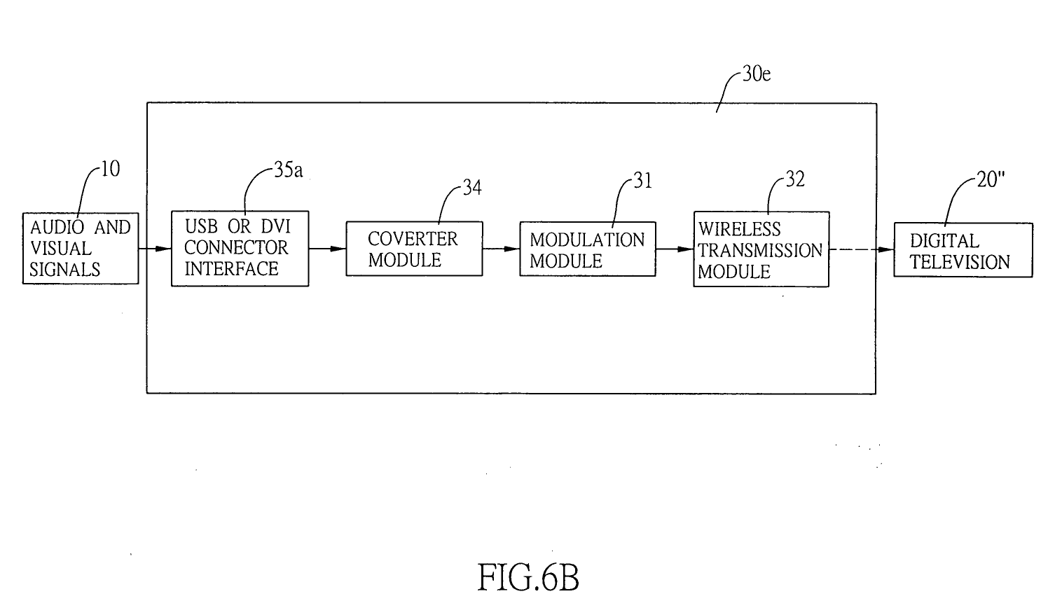

With reference to FIG. 6A and FIG. 6B, a fifth and a sixth preferred embodiment of a wireless transmission device (30d, 30e) of the present invention is approximately similar to the wireless transmission device in the third and the fourth preferred embodiment. The difference is that the wireless transmission device (30d, 30e) of this preferred embodiment uses an USB or DVI connector interface (35a) instead of the VGA connector interface (35) for receiving USB type or DVI type audio and visual data. Since the USB type or DVI type audio and visual data is of digital data, in order to receive and send the digital data, the fifth and the sixth preferred embodiment is somewhat different from the third and the fourth preferred embodiment. In addition, since the fifth embodiment is applied to the CRT television and the USB type or DVI type audio and visual data is of digital data, the fifth embodiment further uses a decoding module (33a). The decoding module (33a) connected between the USB connector interface (35a) and the wireless transmission module (32) decodes the USB type audio and visual data.

It can be clearly understood from the above description that the wireless transmission method for the electronic apparatuses and device thereof of the present invention can apply to general electronic apparatuses to transmit the audio and visual signals to the television to play without using the conventional audio and video connectors. The low-power television signals wireless transmitter transforms the modulated audio and visual signals to the television carrier signals. Then the television carrier signals are sent to the television with the very short distance between the electronic apparatuses and the television. The transmitted carrier signals can go through the television to a tuner inside the television. The television then can direct play the audio and visual signals of the electronic apparatuses when the television is tuned to the setting frequency of the present invention. Moreover, the external connected auxiliary antenna installed on the television can enhance the reception of the audio and visual signals sent by the present invention. Therefore the present invention indeed includes features of good utility and unobviousness to meet the requirements of a patent.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A wireless transmission method for electronic apparatuses to transmit audio and visual signals to a television comprising steps as follows:
modulating audio and visual signals that electronic apparatuses desire to play;
transforming the modulated audio and visual signals to television carrier signals via a low-power television signals wireless transmitter, and then sending the television carrier signals to a television by setting the electronic apparatuses near the television;
with a very short distance between the electronic apparatuses and the television, the transmitted carrier signals going through the television to a tuner inside the television, then the tuner direct receive the television carrier signals; and
the television then direct play the audio and visual signals of the electronic apparatuses by tuning the television to a corresponding frequency of the television carrier signals.

2. The wireless transmission method for electronic apparatuses to transmit audio and visual signals to a television as claimed in claim 1, further comprising installing an auxiliary antenna at an antenna input cable of a television, wherein the auxiliary antenna comprises a cable configured with a metal extending part for enhancing reception sensitivity of the television.

3. The wireless transmission device for electronic apparatuses to transmit audio and visual signals to a television, comprising:
a modulation module used to receive audio and visual signals of electronic apparatuses and then transform the audio and visual signals to a modulated audio and visual signals suitable to be transmitted by a transmission media; and
a low-power wireless transmission module coupled to the modulation module for transmitting the modulated audio and visual signals;
wherein the low-power wireless transmission module has to be installed near a television with a very short distance to make the wireless signals go through the television to a tuner inside the television, so as to transmit the audio and visual signals.

4. The wireless transmission device for electronic apparatuses to transmit audio and visual signals to a television as claimed in claim 3 further comprising:
an encoding module is adapted to connect to the audio and visual signals; and
a converter module connected between the encoding module and modulation module.

5. The wireless transmission device for electronic apparatuses to transmit audio and visual signals to a television as claimed in claim 3 further comprising a connector interface, wherein the connector interface is coupled to the modulation module.

6. The wireless transmission device for electronic apparatuses to transmit audio and visual signals to a television as claimed in claim 4 further comprising a connector interface, wherein the connector interface is coupled to the modulation module.

7. The wireless transmission device for electronic apparatuses to transmit audio and visual signals to a television as claimed in claim 5, wherein the connector interface is an analog data transmission interface.

8. The wireless transmission device for electronic apparatuses to transmit audio and visual signals to a television as claimed in claim 7, wherein the connector interface is a VGA connector interface.

9. The wireless transmission device for electronic apparatuses to transmit audio and visual signals to a television as claimed in claim 5, wherein the connector interface is a digital data transmission interface.

10. The wireless transmission device for electronic apparatuses to transmit audio and visual signals to a television as claimed in claim 9, further comprising a decoding module connected between the digital data transmission interface and the modulation module.

11. The wireless transmission device for electronic apparatuses to transmit audio and visual signals to a television as claimed in claim 9, further comprising a converter connected between the digital data transmission interface and the modulation module.

12. The wireless transmission device for electronic apparatuses to transmit audio and visual signals to a television as claimed in claim 9, wherein the connector interface is an USB or DVI connector interface.

13. The wireless transmission device for electronic apparatuses to transmit audio and visual signals to a television as claimed in claim 3 further comprising an auxiliary antenna installed at an antenna input cable of a television for enhancing reception sensitivity of the television.

14. The wireless transmission device for electronic apparatuses to transmit audio and visual signals to a television as claimed in claim 4 further comprising an auxiliary antenna installed at an antenna input cable of a television for enhancing reception sensitivity of the television.

15. The wireless transmission device for electronic apparatuses to transmit audio and visual signals to a television as claimed in claim 5 further comprising an auxiliary antenna installed at an antenna input cable of a television for enhancing reception sensitivity of the television.

16. The wireless transmission device for electronic apparatuses to transmit audio and visual signals to a television as claimed in claim 6 further comprising an auxiliary antenna installed at an antenna input cable of a television for enhancing reception sensitivity of the television.

17. The wireless transmission device for electronic apparatuses to transmit audio and visual signals to a television as claimed in claim 7 further comprising an auxiliary antenna installed at an antenna input cable of a television for enhancing reception sensitivity of the television.

18. The wireless transmission device for electronic apparatuses to transmit audio and visual signals to a television as claimed in claim 8 further comprising an auxiliary antenna installed at an antenna input cable of a television for enhancing reception sensitivity of the television.

19. The wireless transmission device for electronic apparatuses to transmit audio and visual signals to a television as claimed in claim 9, wherein the auxiliary antenna comprises a cable configured with a metal extending part.

20. The wireless transmission device for electronic apparatuses to transmit audio and visual signals to a television as claimed in claim 10, wherein the auxiliary antenna comprises a cable configured with a metal extending part.
